(19) United States
(12) Patent Application Publication
(10) Pub. No.: US 2014/0330619 A1
(43) Pub. Date: Nov. 6, 2014

(54) METHODS AND SYSTEMS FOR AUTOMATIC, PRE-SALE PRICE MATCHING

(71) Applicant: Baby's Den Inc., Brooklyn, NY (US)

(72) Inventor: Boruch Igal Hatanian, Brooklyn, NY (US)

(73) Assignee: Baby's Den Inc., Brooklyn, NY (US)

(21) Appl. No.: 14/265,403

(22) Filed: Apr. 30, 2014

Related U.S. Application Data
(60) Provisional application No. 61/818,667, filed on May 2, 2013.

(51) Int. Cl. G06Q 30/02

(52) U.S. Cl. CPC G06Q 30/0206
USPC 705/7.35

(57) ABSTRACT

A method for automatic, pre-sale price matching performed by a computing device includes receiving a first price established by a first vendor for at least one of a good and a service. The method includes retrieving information including a second price, the information associated with an offer for sale, by another vendor, of the at least one of the good and the service. The method includes identifying at least one parameter of the offer. The method includes recalculating the second price using the parameter. The method includes determining that the first price is higher than the recalculated second price. The method includes automatically modifying the first price to be substantially equal to the recalculated second price. The method includes publishing the modified first price so a user may acquire the at least one of the good and the service at the modified first price from the first vendor without negotiation.

### CROSS-REFERENCE TO RELATED APPLICATIONS

This application claims priority from U.S. Provisional Patent Application No. 61/818,667, filed on May 2, 2013, entitled “Methods and Systems for Automatic, Pre-Sale Price Matching,” which is hereby incorporated by reference.

### BACKGROUND

The disclosure relates to facilitating the comparison of pricing and other data in commercial transactions. More particularly, the methods and systems described herein relate to functionality for automatic, pre-sale price matching.

Price-matching guarantees are an increasingly vital tool for brick-and-mortar retailers who wish to compete with online vendors. Absent the ability to match the prices of the online retailers, who often offer substantial discounts and deliver the goods or services to the customer in the comfort of the home, traditional vendors become glorified show rooms. Customers come to the vendor to look at a product in person and try it out, then return to their houses to purchase it from an online retailer. By matching or undercutting the online vendor's prices, the traditional vendor has some hope of once again becoming the more convenient option, as the customers can both inspect and purchase the product in a single step.

Conventionally, price-matching guarantees provide customers with a certain period in which to encounter a lower price at another vendor's location and present evidence of that lower price to the vendor offering the guarantee. This typically requires some bureaucratic maneuvering by the customer. For example, there are typically forms to fill out, and there may be the need to present the forms and the evidence to an employee, which in turn may lead to some negotiation or haggling about the validity of the evidence presented and the terms of the price-matching program; additionally, there may be a limited number of employees authorized to handle price-matching requests, so the customer may have to wait in line or make an appointment. Combined with the additional effort of acquiring the evidence of superior pricing and returning to the vendor with that evidence, this bureaucracy can dissuade most customers from even trying to take advantage of the price-matching guarantees.

### BRIEF SUMMARY

In one aspect, a method includes receiving, by a computing device, a first price established by a first vendor for at least one of a good and a service. The method includes retrieving, by the computing device, information associated with an offer for sale, by a second vendor, of the at least one of the good and the service, the retrieved information including a second price. The method includes identifying, by the computing device, at least one parameter of the offer for sale, the parameter limiting availability of the second price. The method includes recalculating, by the computing device, the second price, based upon the at least one identified parameter. The method includes determining, by the computing device, that the first price is higher than the recalculated second price. The method includes automatically modifying, by the computing device, the first price so that the first price is substantially equal to the recalculated second price, based on the determination. The method includes publishing, by the computing device, the modified first price in a form with which the user may acquire the at least one of the good and the service at the modified first price from the first vendor without negotiation.

In another aspect, a system includes a computing device receiving data captured from a scanned price code associated with at least one of a good and a service offered for sale by a first vendor. The system includes a price capture module executing on the computing device and identifying, based upon the received data, a first price established by the vendor for the at least one of the good and the service. The system includes a search module executing on the computing device and retrieving information associated with an offer for sale, by a second vendor, of the at least one of the good and the service, the retrieved information including a second price. The system includes a price modification module executing on the computing device, identifying at least one parameter of the offer for sale, the parameter limiting availability of the second price, recalculating the second price, based upon the at least one identified parameter, determining that the first price is higher than the recalculated second price, and automatically modifying the first price so that the first price is substantially equal to the recalculated second price, based on the determination. The system includes a publishing module executing on the computing device and publishing the modified first price in a form with which the user may acquire the at least one of the good and the service at the modified first price from the first vendor without negotiation.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-1C are block diagrams depicting embodiments of computers useful in connection with the methods and systems described herein;

FIG. 2A is a block diagram depicting an embodiment of a system for automatic, pre-sale price matching;

FIG. 2B is a block diagram depicting another embodiment of a system for automatic, pre-sale price matching;

FIG. 3 is a flow diagram depicting an embodiment of a method for automatic, pre-sale price matching;

FIG. 4 is a flow diagram depicting another embodiment of a method for automatic, pre-sale price matching; and

FIG. 5 is a flow diagram depicting another embodiment of a method for automatic, pre-sale price matching.

### DETAILED DESCRIPTION

In some embodiments, the methods and systems described herein provide functionality for automatic, pre-sale price matching. Before describing these methods and systems in detail, however, a description is provided of a network in which such methods and systems may be implemented.

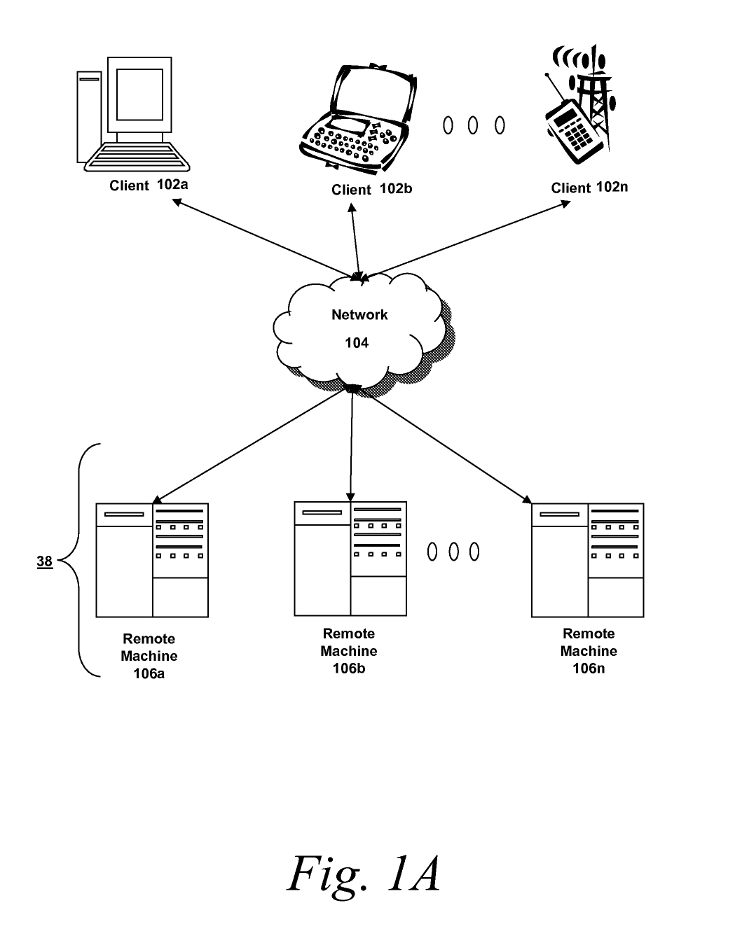

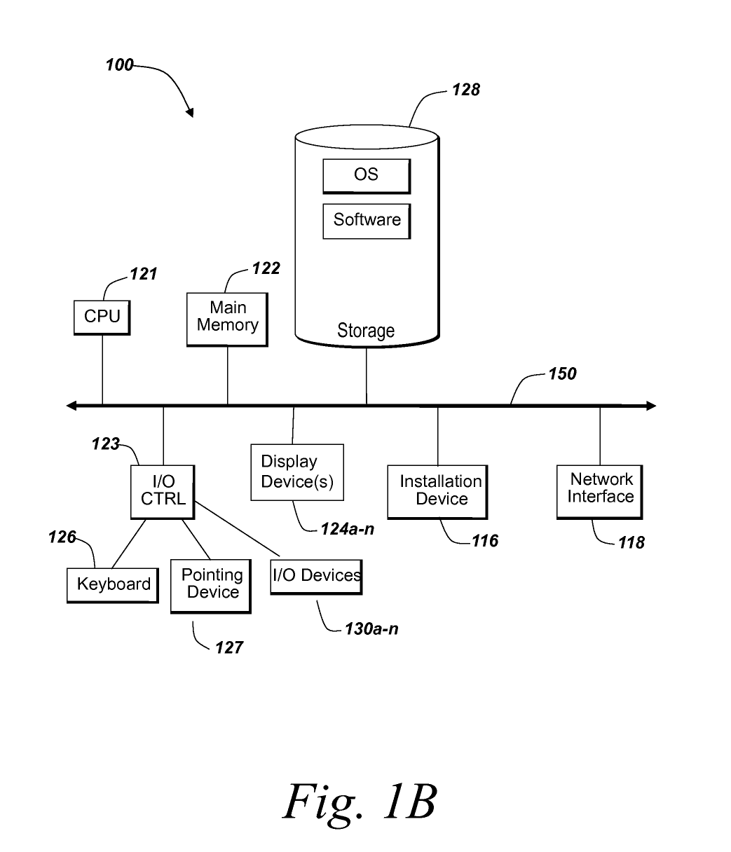

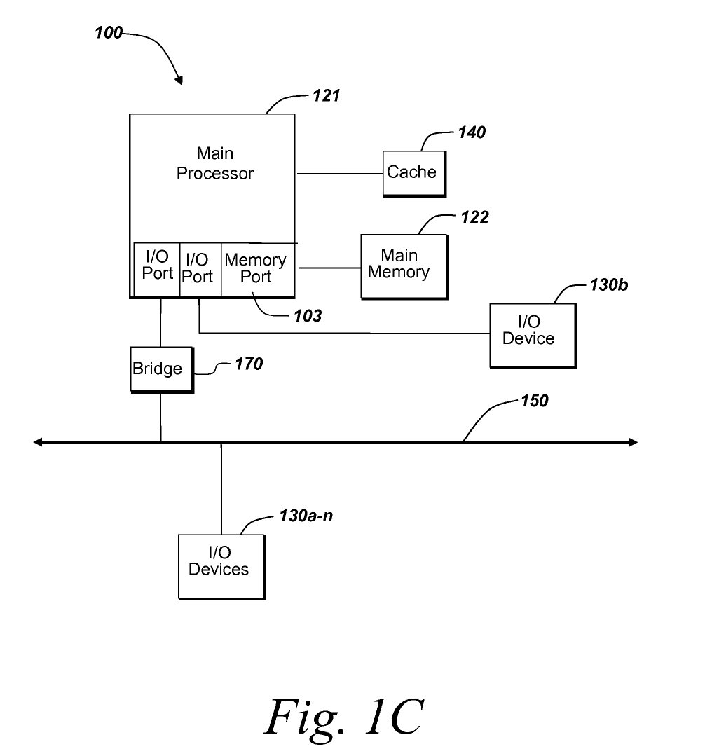

Referring now to FIG. 1A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 104.

Although FIG. 1A shows a network 104 between the clients 102 and the remote machines 106, the clients 102 and the remote machines 106 may be on the same network 104. The network 104 can be a local area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS, or UMTS. In some embodiments, different types of data may be transmitted via different protocols. In other embodiments, the same types of data may be transmitted via different protocols.

A client 102 and a remote machine 106 (referred to generally as computing devices 100) can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 102 may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on client 102.

In one embodiment, a computing device 106 provides functionality of a web server. In some embodiments, a web server 106 comprises an open-source web server such as the APACHE servers maintained by the Apache Software Foundation of Delaware. In other embodiments, the web server executes proprietary software such as the Internet Information Services products provided by Microsoft Corporation of Redmond, Wash., the Oracle iPlanet web server products provided by Oracle Corporation of Redwood Shores, Calif., or the BEA WEBLOGIC products provided by BEA Systems of Santa Clara, Calif.

In some embodiments, the system may include multiple, logically-grouped remote machines 106. In one of these embodiments, the logical group of remote machines may be referred to as a server farm 38. In another of these embodiments, the server farm 38 may be administered as a single entity.

FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, a pointing device 127, such as a mouse, and one or more other I/O devices 130a-n. The storage device 128 may include, without limitation, an operating system and software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121. The main memory 122 may be based on any available memory chips capable of operating as described herein. In the embodiment shown in FIG. 1B, the processor 121 communicates with main memory 122 via a system bus 150. FIG. 1C depicts an embodiment of a computing device 100 in which the processor communicates directly with main memory 122 via a memory port 103. FIG. 1C also depicts an embodiment in which the main processor 121 communicates directly with cache memory 140 via a secondary bus, sometimes referred to as a backside bus. In other embodiments, the main processor 121 communicates with cache memory 140 using the system bus 150.

In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 also communicates directly with an I/O device 130b via, for example, HYPERTRANSPORT, RAPIDIO, or INFINIBAND communications technology.

A wide variety of I/O devices 130a-130n may be present in the computing device 100. Input devices include keyboards, mice, trackpads, trackballs, microphones, scanners, cameras, and drawing tablets. Output devices include video displays, speakers, inkjet printers, laser printers, and dye-sublimation printers. The I/O devices may be controlled by an I/O controller 123 as shown in FIG. 1B. Furthermore, an I/O device may also provide storage and/or an installation device 116 for the computing device 100. In some embodiments, the computing device 100 may provide USB connections (not shown) to receive handheld USB storage devices such as the USB Flash Drive line of devices manufactured by Twintech Industry, Inc. of Los Alamitos, Calif.

Referring still to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive, or any other device suitable for installing software and programs. The computing device 100 may further comprise a storage device, such as one or more hard disk drives or redundant arrays of independent disks, for storing an operating system and other software.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, SS7, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). In some embodiments, the computing device 100 provides communications functionality including services such as those in compliance with the Global System for Mobile Communications (GSM) standard or other short message services (SMS). The network interface 118 may comprise a built-in network adapter, network interface card, PCMCIA network card, card bus network adapter, wireless network adapter, USB network adapter, modem, or any other device suitable for interfacing the computing device 100 to any type of network capable of communication and performing the operations described herein.

In some embodiments, the computing device 100 may comprise or be connected to multiple display devices 124a-124n, each of which may be of the same or different type and/or form. As such, any of the I/O devices 130a-130n and/or the I/O controller 123 may comprise any type and/or form of suitable hardware, software, or combination of hardware and software to support, enable, or provide for the connection and use of multiple display devices 124a-124n by the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus such as a USB bus, an Apple Desktop bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, and WINDOWS VISTA, all of which are manufactured by Microsoft Corporation of Redmond, Wash.; MAC OS manufactured by Apple Inc. of Cupertino, Calif.; OS/2 manufactured by International Business Machines of Armonk, N.Y.; and Linux, a freely-available operating system distributed by Caldera Corp. of Salt Lake City, Utah, or any type and/or form of a Unix operating system, among others.

The computing device 100 can be any workstation, desktop computer, laptop or notebook computer, server, portable computer, mobile telephone or other portable telecommunication device, media playing device, a gaming system, mobile computing device, or any other type and/or form of computing, telecommunications, or media device that is capable of communication and that has sufficient processor power and memory capacity to perform the operations described herein. In some embodiments, the computing device 100 may have different processors, operating systems, and input devices consistent with the device. In other embodiments the computing device 100 is a mobile device, such as a JAVA-enabled cellular telephone or personal digital assistant (PDA). The computing device 100 may be a mobile device such as those manufactured, by way of example and without limitation, by Motorola Corp. of Schaumburg, Ill.; Kyocera of Kyoto, Japan; Samsung Electronics Co., Ltd. of Seoul, Korea; Nokia of Finland; Hewlett-Packard Development Company, L.P. and/or Palm, Inc. of Sunnyvale, Calif.; Sony Ericsson Mobile Communications AB of Lund, Sweden; or Research In Motion Limited of Waterloo, Ontario, Canada. In yet other embodiments, the computing device 100 is a smart phone, Pocket PC, Pocket PC Phone, or other portable mobile device supporting Microsoft Windows Mobile Software.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices manufactured by Apple Inc. of Cupertino, Calif. In another of these embodiments, the digital audio player may function as both a portable media player and as a mass storage device. In other embodiments, the computing device 100 is a digital audio player such as those manufactured by, for example and without limitation, Samsung Electronics America of Ridgefield Park, N.J., Motorola Inc. of Schaumburg, Ill., or Creative Technologies Ltd. of Singapore. In yet other embodiments, the computing device 100 is a portable media player or digital audio player supporting file formats including, but not limited to, MP3, WAV, M4A/AAC, WMA Protected AAC, AEFF, Audible audiobook, Apple Lossless audio file formats, and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a device in the Motorola line of combination digital audio players and mobile phones. In another of these embodiments, the computing device 100 is a device in the iPhone smartphone line of devices manufactured by Apple Inc. of Cupertino, Calif. In still another of these embodiments, the computing device 100 is a device executing the Android open source mobile phone platform distributed by the Open Handset Alliance; for example, the device 100 may be a device such as those provided by Samsung Electronics of Seoul, Korea or HTC Headquarters of Taiwan, R.O.C. In other embodiments, the computing device 100 is a tablet device such as, for example and without limitation, the iPad line of devices manufactured by Apple Inc.; the PlayBook manufactured by Research In Motion; the Cruz line of devices manufactured by Velocity Micro, Inc. of Richmond, Va.; the Folio and Thrive line of devices manufactured by Toshiba America Information Systems, Inc. of Irvine, CA; the Galaxy line of devices manufactured by Samsung; the HP Slate line of devices manufactured by Hewlett-Packard; and the Streak line of devices manufactured by Dell, Inc. of Round Rock, Tex.

In some embodiments, the methods and systems described herein provide functionality for automatically changing a vendor's price for a product or service to match a lower price offered by a competitor, prior to a sale of that product or service. More particularly, the method relates to functionality for scanning the vendor's initial price, locating a lower price currently offered by a competitor, and modifying the vendor's initial price to one substantially equal to or less than the competitor's price, without the need for any effort by the consumer beyond the initial scanning Furthermore, the methods and systems described herein relate to functionality for printing, displaying, or transmitting, to the vendor's point of sale systems, the modified price so that a consumer can pay that price for the good or service, without having to negotiate with an employee, or even to inform the employee that the price-matching transaction has occurred.

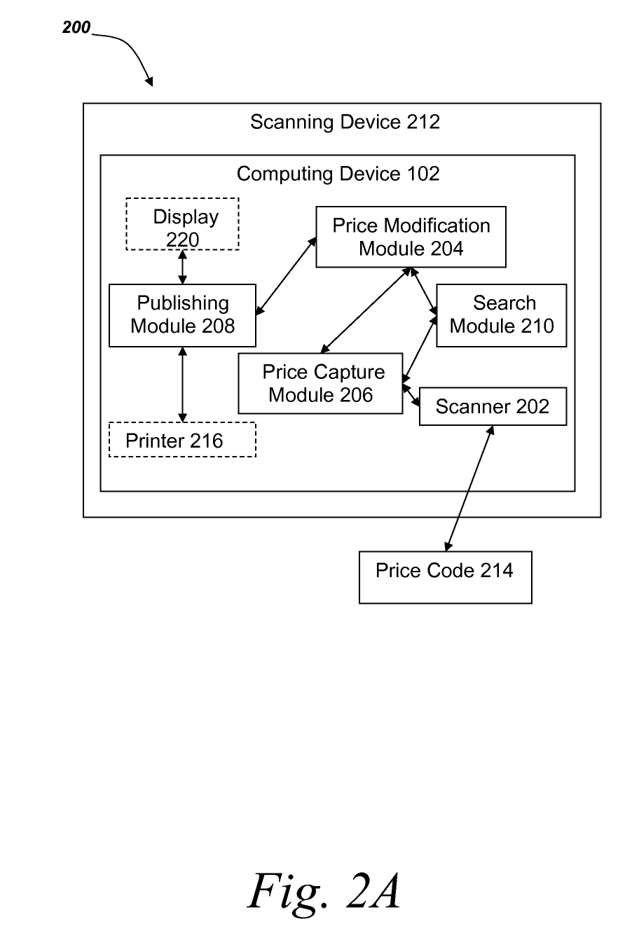

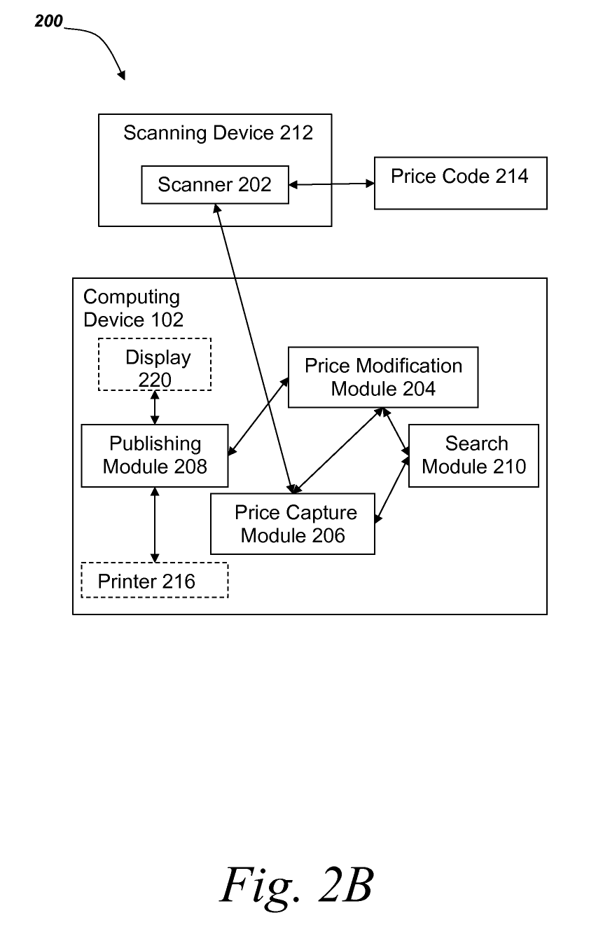

Referring now to FIG. 2A, a block diagram depicts one embodiment of a system for automatic, pre-sale price matching. In brief overview, a system 200 includes a scanning device 212, a scanner 202, a price modification module 204, a price capture module 206, a publishing module 208, and a search module 210. The scanning device 212 includes the scanner 202. In one embodiment, the scanning device 212 includes a machine 100 as described above in connection with FIGS. 1A-1C. In another embodiment, the scanning device 212 is in communication with a computing device 102; for example, the scanning device 212 may connect directly to the computing device 106 or the scanning device 212 may access the computing device 106 over a network 104.

In one embodiment, and as shown in FIG. 2A, the scanning device 212 includes a computing device 102, providing the functionality of a machine 100 as described above in connection with FIGS. 1A-1C. As indicated above in connection with FIGS. 1A-1C, the computing device 102 may be provided as a mobile computing device, such as a smart phone. In one embodiment, the scanning device 212 includes a digital camera. In another embodiment, the computing device 102 includes the price modification module 204, the price capture module 206, the publishing module 208, and the search module 210.

Referring ahead to FIG. 2B, a block diagram depicts an embodiment of a system for automatic, pre-sale price matching. As depicted in FIG. 2B, the scanning device 212 includes the scanner 202 and is in communication with a computing device 102, which provides the price modification module 204, the price capture module 206, the publishing module 208, and the search module 210. In other embodiments (not shown), the system 200 includes several computing devices 102, combined to function together and perform as a coordinated unit, as set forth in additional detail below.

Referring back to FIG. 2A, the scanner 202 may provide functionality for capturing data in a plurality of data formats. Alternatively, a particular scanner 202 may provide functionality specifically for capturing data in a particular format. For instance, if pricing information and other product data to be scanned is encoded as a universal product code (UPC), the scanner 202 may be a laser scanner that reads the UPC and translates it into digital data containing the pricing information and product data. Other examples of scanners 202 include, without limitation, optical scanners, digital cameras, radio frequency identification (RFID) readers, and magnetic readers. In one embodiment, the scanning device 212 is provided as a mobile computing device 102, such as a smart phone, and the scanner 202 is a digital camera provided by the smart phone.

In one embodiment, the scanning device 212 and the scanner 202 are provided together as a special-purpose portable scanning system 212, such as a “price gun,” with embedded code or circuitry serving as the computing device 102. In such an embodiment, the scanning device 212 may include a display 220, e.g., a liquid crystal display unit. Additionally, the scanning device 212 may include a printer 216. In another such an embodiment, the scanning device 212 may include functionality, such as an I/O controller 123, for connecting the scanning device 212 to an external I/O device 130, such as an external display or external printer. In some embodiments, the scanning device 212 may use printers or displays to publish information about scanned or modified data. In other embodiments, the scanning device 212 is provided as a special-purpose computing device 102 designed for processing payments with an integrated or attached scanner (e.g., a cash register). In further embodiments, the scanning device 212 is in communication with a payment processing machine (not shown) maintained by the first vendor and receiving the modified first price from the publishing module.

In one embodiment, the scanning device 212 provides functionality for scanning price codes; for capturing, from scanned price codes, price data established by a first vendor for a good or service; for determining whether a second vendor offers a substantially similar good or service for a lower price; and for automatically modifying the captured price data. In another embodiment, the scanning device 212 is in communication with a computing device 102 that provides this functionality. One or more of the price modification module 204, the price capture module 206, the publishing module 208, and the search module 210 may also provide such functionality.

In one embodiment, the price modification module 204 is provided as part of a software application provided by the scanning device 212; for example, the scanning device 212 may be provided as a smart phone executing a mobile application that includes the functionality of the price modification module 204. In another embodiment, the price modification module 204 executes on the computing device 102 within, or in communication with, the scanning device 212. In still another embodiment, the price modification module 204 is provided as a hardware application.

In one embodiment, the price capture module 206 is provided as part of a software application provided by the scanning device 212; for example, the scanning device 212 may be provided as a smart phone executing a mobile application that includes the functionality of the price capture module 206. In another embodiment, the price capture module 206 executes on the computing device 102 within, or in communication with, the scanning device 212. In still another embodiment, the price capture module 206 is provided as a hardware application.

In one embodiment, the publishing module 208 is provided as part of a software application provided by the scanning device 212; for example, the scanning device 212 may be provided as a smart phone executing a mobile application that includes the functionality of the publishing module 208. In another embodiment, the publishing module 208 executes on the computing device 102 within, or in communication with, the scanning device 212. In still another embodiment, the publishing module 208 is provided as a hardware application.

In one embodiment, the search module 210 is provided as part of a software application provided by the scanning device 212; for example, the scanning device 212 may be provided as a smart phone executing a mobile application that includes the functionality of the search module 210. In another embodiment, the search module 210 executes on the computing device 102 within, or in communication with, the scanning device 212. In still another embodiment, the search module 210 is provided as a hardware application.

Although for ease of discussion the price modification module 204, the price capture module 206, the publishing module 208, and the search module 210 are described as separate modules, it should be understood that this does not restrict the architecture to a particular implementation. For instance, these modules may be encompassed by a single circuit or software function.

In some embodiments, a mobile application executing on the scanning device 212 includes one or more of the price modification module 204, the price capture module 206, the publishing module 208, and the search module 210. In one embodiment, a scanning device 212 is formed by the execution of such a mobile application on a machine 100 that provides a digital camera as a scanner 202. For instance, a consumer could download the mobile application to her mobile computing device 102 and use the digital camera provided by the mobile computing device 102 with the mobile application; in such an embodiment, the mobile computing device 102 is providing the functionality of the scanning device 212.

In some embodiments, the system 200 includes a plurality of scanning devices 212. As an example, upon entering a store, the consumer's mobile computing device 102 could wirelessly connect to other computing devices 102 within the store, including computing devices 106 maintained by a retailer and including, or in communication with, a payment processing machine. As a result, the mobile computing device 102 and the retailer computing devices 106, along with any other devices accessible to either, would together comprise a distributed system 200. Likewise, a special-purpose price gun owned either by the customer or by the vendor in communication with other computing devices 102 in the store may form a system 200.

The scanner 202 extracts product data from a price code 214, which is an object, image or device from which a scanning device 212 can extract pricing information concerning a product. Price codes 214 may include, without limitation, bar codes (e.g., UPC), quick-read (QR) codes, radio frequency identification (RFID) tags, and similar objects that encode digital pricing information in, for example, pigment, circuitry, and magnetic coded forms. In some embodiments, a price code 214 includes a conventional price tag and the scanning device 212 includes functionality for scanning the conventional price tag and translating the price listed on it into a digital format. In addition, any information that the scanner 202 is capable of capturing that identifies a particular product under consideration can function as a price code 214 if the scanning device 212 has a way to associate that product with its pricing information. For instance, in one embodiment, a scanning device 212 includes functionality for scanning serial numbers or product identification codes using the scanner 202 and looking up corresponding prices in a database to which the system 200 has access (not shown).

In some embodiments, the search module 210 performs the task of searching the Internet, or a similar network, to discover competitors' offers. The price modification module 204, in some embodiments, compares the vendor's price, as acquired by the price capture module 206, to a price offered by a competitor as identified by the search module 210. In some embodiments as described above, the publishing module 208 publishes the new price derived by the price modification module 204.

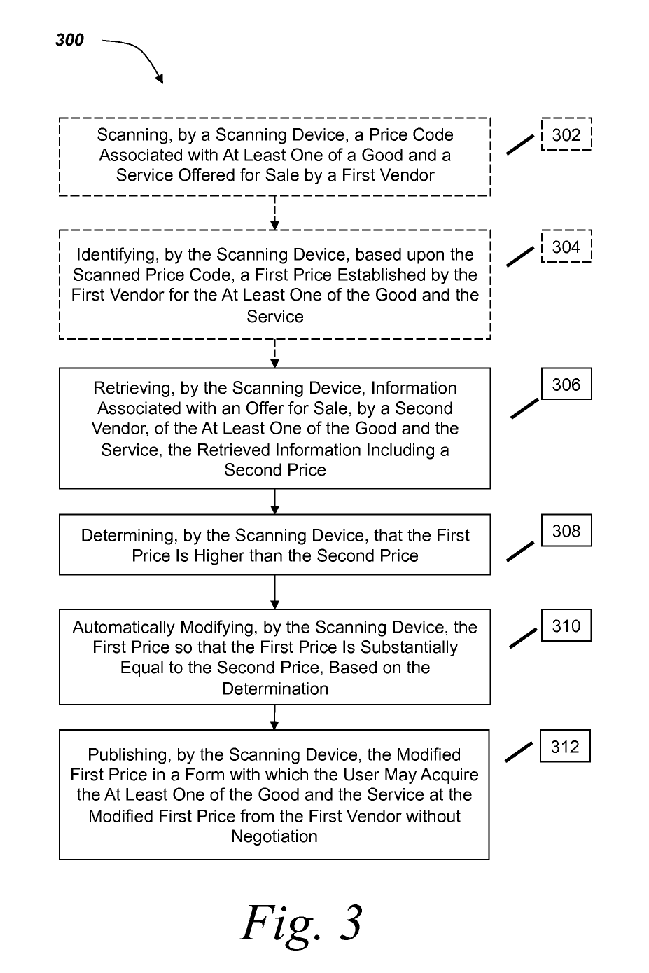

Referring now to FIG. 3, a flow diagram depicts one embodiment of a method 300 for automatic, pre-sale price matching. In brief overview, the method 300 includes retrieving, by the scanning device, information associated with an offer for sale, by a second vendor, of the at least one of the good and the service, the retrieved information including a second price (306). The method 300 includes determining, by the scanning device, that the first price is higher than the second price (308). The method 300 includes automatically modifying, by the scanning device, the first price so that the first price is substantially equal to the second price, based on the determination (310). The method includes publishing, by the scanning device, the modified first price in a form with which the user may acquire the at least one of the good and the service at the modified first price from the first vendor without negotiation (312). In some embodiments, the method 300 also includes scanning, by a scanning device, a price code associated with at least one of a good and a service offered for sale by a first vendor, as shown in shadow at (302). In some embodiments, the method 300 also includes identifying, by the scanning device, based upon the scanned price code, a first price established by the first vendor for the at least one of the good and the service, as shown in shadow at (304). In alternative embodiments, the method 300 receives an identification of the first price without requiring the scanning of a price code. For instance, the method 300 may include receiving, from a user, a manually-entered identification of the at least one of the good and the service and uses the manually-entered identification to identify the first price. As another example, the method 300 may include receiving, from the user, a manually-entered identification of the first price. As a further example, the method 300 may include displaying, to a user, an enumeration of goods and services; receiving, from the user, a selection of one of the enumeration of goods and services and an identification of the first price. In such an example, it is possible to receive the first price and to receive the information needed to search for the second price without scanning a price code.

Referring now to FIG. 3 in greater detail, and in connection with FIGS. 2A-2B, the method 300 may include scanning, by a scanning device, a price code associated with at least one of a good and a service offered for sale by a first vendor (302). In one embodiment, the scanner 202 scans the price code 214 associated with the at least one of the good and the service. In another embodiment, the price code 214 is attached to the good. In still another embodiment, the price code 214 is attached to packaging containing the good. In another embodiment, the price code 214 is attached to a description of the service. In still another embodiment, the price code 214 is displayed next to a product on a shelf or a similar location, or kept near a cash register where the scanning occurs. In yet another embodiment, the price code 214 is compatible with the scanner 202 that the scanning device 212 employs.

In one embodiment, the scanner 202 is a laser scanner and the price code is a universal product code (UPC). In another embodiment, in which the scanner 202 is a digital camera reading a conventional price tag or serial number, the scanner 202 includes functionality for recognizing scanned images, translating them into an alphanumeric string buffer, and then parsing that buffer to extract numerical and character variables containing the appropriate meanings. In some embodiments, the scanner 202 forwards a result of scanning the price code 214 to the price capture module 206.

The scanning device may identify, based upon the scanned price code, a first price established by the first vendor for the at least one of the good and the service (304). In one embodiment, the price capture module 206 identifies the first price, based on data provided by the scanner 202. In some embodiments, the price capture module 206 extracts data from a scanned image generated by the scanner 202. In one of these embodiments, the scanner 202 scans the price code and provides the scanned data to the price capture module 206, which parses the retrieved data to identify the first price. In other embodiments, the price capture module 206 queries a database to identify the first price for the product identified by the price code. In still other embodiments, the price may be recorded in the result of the scan of the price code 214. In further embodiments, the scanning device 212 may scan the price code and identify the first price in a conventional manner

In some embodiments, the price capture module 206 consults a memory of the scanning device 212 (e.g., main memory 122 or storage 128) for the price associated with a datum, such as a serial number, corresponding to a particular product in other embodiments. In embodiments where the scanner 202 is a digital camera, the price capture module 206 may execute an image recognition process and translate the result into numerical or other data. In some embodiments, the price capture module 206 forwards, to the price modification module 204, binary data acquired by the scanner 202 from the price code 214.

The scanning device retrieves information associated with an offer for sale, by a second vendor, of the at least one of the good and the service, the retrieved information including a second price (306). In one embodiment, the search module 210 retrieves the information. In another embodiment, the search module 210 queries a remote server 106 to retrieve the information. In still another embodiment, the search module 210 may include functionality for querying a search engine that then displays pricing and date information for second and subsequent offers in its results.

In one embodiment, the search module 210 locates and downloads data associated with the offer by the second vendor; for example, by executing at least one search query. In such an embodiment, the scanning device 212 may connect to a network 104 and transmit a query to a computing device 106 for information concerning competitors' offers for sale. By way of example, the computing device 106 may be a server 106 that hosts a competitor's website, which displays the competitor's offers of sale to the public. As another example, the computing device 106 may be a remote machine 106 maintained by a third party that aggregates and displays offers from various vendors. As a further example, the search module 210 may access the websites of a list of known competitors or use a search engine to locate offers pertaining to a particular product or service. In some embodiments, the search module 210 also parses the results it obtains during its searches, extracting prices corresponding to the product in question, and then passing the prices it discovers to the price modification module 204, or storing them in memory available to the computing device 102. The process of retrieving information associated with an offer for sale, by a second vendor, of the at least one of the good and the service may be performed on demand at the moment of price assessment, or it may be performed by periodically scanning the network for new offers and saving them to a database or some other readily accessible memory format. In some embodiments retrieving includes retrieving, by the scanning device 212, information associated with each of a plurality of offers for sale from each of a plurality of vendors, the retrieved information including a price associated with each offer for sale; determining, by the scanning device, which of the plurality of offers for sale is associated with the lowest price included in the plurality of offers for sale; and selecting, for comparison with the first price, the determined offer for sale.

In some embodiments, retrieving the information includes determining the date or duration of the offer for sale. In one of these embodiments, the search module 210 may remove an offer for consideration if the offer is not current. The scanning device 212 may receive data associated with the offer for sale and extract pricing information from the received data; for example, the price capture module 206 may extract the pricing information.

The method 300 includes determining, by the scanning device, that the first price is higher than the second price (308). In one embodiment, the price modification module makes the determination. The price modification module 204, in some embodiments, identifies the lowest available competitor price from the prices identified by the search module 210 and compares the vendor's price, as acquired by the price capture module 206, to the lowest available competitor price. Having selected the competitor price with which to compare the vendor price, the price modification module 204 may proceed to compare the two numbers to determine whether to modify the first price. Where there are multiple sale offers to assess, the price comparison module 204 may perform the steps necessary to identify the lowest price. Those of ordinary skill will be aware of many efficient sorting algorithms that can be implemented on computing devices as disclosed in reference to FIGS. 1A-1C, which are designed to rapidly rank a set of objects by magnitude. In some embodiments, discovering the lowest competitor price involves execution of a sorting algorithm. The choice of sorting algorithm is likely to be dictated, for a particular implementation, by the volume of competitor prices to be sorted. Once the price modification module 204 has found the lowest competitor price from the set of available prices, it can proceed to compare it to the vendor's first price. In one embodiment, the price comparison module 204 performs a comparison in magnitude between numbers, particularly in embodiments wherein the price modification module 204 compares one competitor's price with the vendor's initial price.

In one embodiment, the price modification module 204 also analyzes offer data other than prices to identify conditions that may modify the price offered by the second vendor; for example, conditions may specify that where the offer for sale is a promotion, or for special offers such as a sale, the price is discounted from a vendor's ordinary price, but only within limited parameters. For instance, the second, discounted price could be available for a limited duration (e.g., on the Friday after Thanksgiving). The second price might be available only for a limited quantity of objects, with the rest of the vendor's stock offered at higher prices. As another example of a condition, the discounted price might also be available only if the consumer makes additional purchases, or only if the consumer trades in value in another form, such as a used item in exchange for which the second vendor will give the consumer credit toward the price of the new purchase. The price comparison may be designed to take those parameters concerning an offer for sale into account when making the comparison. For instance, some embodiments assign a monetary value to the probability that a consumer would like to avoid making an additional purchase to obtain the discounted price and add that value to the price to which the vendor's initial price is compared. In one embodiment, the method 300 includes identifying a parameter of the second vendor's offer for sale; recalculating the second price, based upon the identified parameter; and lowering the first price so that the first price is substantially equal to the second price as dictated by the parameter.

The scanning device automatically modifies the first price so that the first price is substantially equal to the second price, based on the determination (310). In some embodiments, the scanning device 212 automatically modifies the first price so that the first price is lower than the second price, based on the determination. In another embodiment, the price comparison module 204 automatically modifies the first price.

In one embodiment, the scanning device 212 performs the automatic modification as soon as it is determined that the first price is higher than the second price. In another embodiment, the scanning device 212 performs the automatic modification upon receiving a request from a user to modify the first price. For example, the scanning device 212 may publish the first price and the second price to a user of the scanning device 212. In this example, the user has the option of requesting the automatic modification and the scanning device does not modify the first price until the user requests the modification. As another example, the scanning device 212 may display a user interface element requesting input from the user regarding whether or not to modify the first price. In some instances, as will be discussed in greater detail below, the first vendor cannot or will not provide a price that is lower than the second price but may be willing or able to offer a reduction to the first price by another amount so that the modified first price is higher than the second price but lower than the original first price; in such an instance, the scanning device 212 may also display a user interface element requesting an instruction from a user regarding whether to make the reduction.

In one embodiment, the price comparison module 204 determines whether to modify the competitor's price according to the context of the competitor's offer (e.g., accounting for conditions and other restrictions on price as discussed above). In other embodiments, the price modification module 204 sets the first vendor's price equal to the lower competitor's price, if the goal is simply to match that price. In still other embodiments, in which the goal is to present a price that is less than the competitor's price, the price modification module 204 determines how much lower the price should be set.

In some embodiments, the basis of the calculation may be psychological: how much lower than the lowest competitor's price does the modified price have to be in order to induce consumers to buy from the first vendor, rather than from the competitor? This may involve weighing the loss of profit margin on a given sale from additional discounting against the loss of business to a competitor at a less-reduced price. An additional concern is the possibility that a given price will be so low that matching it will cost the vendor more than the additional business brought in by the price reduction is worth. In some embodiments, the methods and systems described herein avoid this issue by maintaining a minimum price for the product or service in question in the memory of the scanning device 212, or in the memory of a database or another device from which the scanning device 212 can retrieve data. The price modification module 204 then compares the competitor's price not only to the first vendor's original price but also to that minimum price. If the competitor's price is less than the minimum price, then, in some embodiments, the price modification module 204 does not lower the first vendor's price to match the competitor's price. In other embodiments, if the competitor's price is lower than the minimum price, the price modification module 204 reduces the vendor's original price only to the minimum price. In one embodiment, the method 300 includes maintaining, in memory accessible to the scanning device, a minimum price value for the at least one of the good and the service; determining, by the scanning device, that the minimum price is higher than the second price; and refraining from modifying the first price.

The scanning device 212 publishes the modified first price in a form with which the user may acquire the at least one of the good and the service at the modified first price from the first vendor without negotiation (312). In one embodiment, the publishing module 208 performs the publication. In another embodiment, publication includes transmitting the modified first price to a computing device maintained by the first vendor. “Publishing” in this context may refer to either (1) informing the user of the price, or (2) enabling the user to acquire at least one of the good or service to which the price pertains from the vendor for that price, or (3) a combination of both (1) and (2). For instance, the publishing module 208 could “publish” the price by printing out a UPC encoding that price using a printer 216 available to, or incorporated in, the computing device 102 so that the vendor, upon scanning the UPC at a cash register, will see the new price displayed on that cash register and charge the customer accordingly. Publication may also include a display of the price, by the publishing module 208, to the user, via a display 220 available to the computing device 102, and updating the merchant's cash registers so that upon reading the product's original price code, the new price would display at the register.

In some embodiments, publication includes the automatic acceptance of the published modified price by the device used by the vendor to process payments. For instance, the publishing module 208 may direct a printer 216 available to the scanning device 212 to print out a UPC encoding the modified price, which the vendor's cash register would read as if it were the original UPC, requiring no action from the employee at the cash register. The printer 216 may be integrated in the scanning system 212, and may even be a component of a special-purpose self-contained object such as a price gun with an integrated receipt printer. In other embodiments, publication involves displaying a UPC or other price code that may be optically scanned (e.g., a QR code) on the screen of a mobile device. Where the scanning device 212 includes at least one machine maintained by the first vendor, publication may involve updating the machine memory of the vendor's payment process device so that it recognizes the product or service to be purchased and applies the modified price. In some embodiments, implementation of the methods and systems described herein resolves a question of whether to modify the price for the particular good or service this particular consumer is purchasing, or to modify the price for every equivalent product or service in the store. The former may be accomplished by transmitting a variable identifying the customer, or the computing device 102 the customer is currently using, to the computing device 106 that processes payments.

In some embodiments, the publishing module 208 is incorporated into a vendor's payment processing system and allows the user to complete a purchase of the at least one of the good and the service at the modified first price from the scanning device 212. In one of these embodiments, for example, the scanning device includes functionality for displaying the modified first place, receiving a payment from the user and completing the purchase.

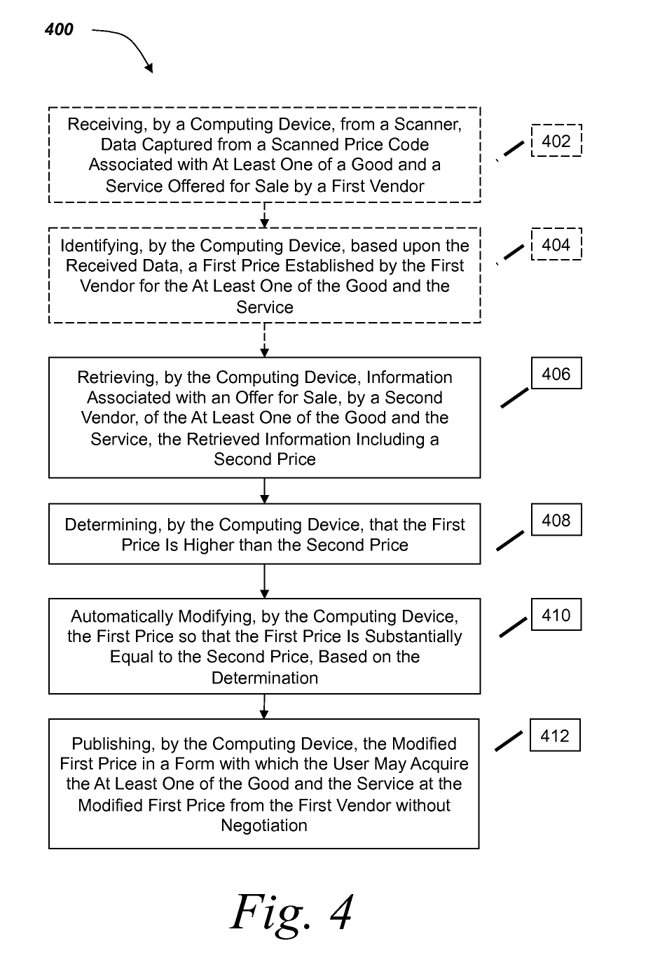

Referring now to FIG. 4, a flow diagram depicts an embodiment of a method 400 for automatic, pre-sale price matching. In brief overview, the method 400 includes retrieving, by the computing device, information associated with an offer for sale, by a second vendor, of the at least one of the good and the service, the retrieved information including a second price (406). The method 400 includes determining, by the computing device, that the first price is higher than the second price (408). The method 400 includes automatically modifying, by the computing device, the first price so that the first price is substantially equal to the second price, based on the determination (410). The method 400 includes publishing, by the computing device, the modified first price in a form with which the user may acquire the at least one of the good and the service at the modified first price from the first vendor without negotiation (412). In some embodiments, the method 400 may include receiving, by a computing device, from a scanner, data captured from a scanned price code associated with at least one of a good and a service offered for sale by a first vendor, as shown in shadow at FIG. 4, (402). In some embodiments, the method 400 includes identifying, by the computing device, based upon the received data, a first price established by the first vendor for the at least one of the good and the service, as shown in shadow at FIG. 4, (404).

Referring now to FIG. 4 in greater detail, and in connection with FIGS. 2A-2B and 3, the computing device 102 may receive, from a scanning device 212, data captured from a scanned price code 214 associated with at least one of a good and a service offered for sale by a first vendor (402). In one embodiment, the scanning device 212 includes the scanner 202 that scans the price code 214 as described above in connection with FIGS. 2A-2B and 3. In another embodiment, and as depicted in FIGS. 2B and 4, the scanning device 212 is a conventional scanner, such as a “price gun,” and the computing device 102 provides the functionality for automatic, pre-sale price matching.

The method 400 may include identifying, by the computing device, based upon the received data, a first price established by the first vendor for the at least one of the good and the service (404). In one embodiment, the price capture module 206 receives the scanned data and identifies the first price. This step may be achieved by the price capture module 206 as set forth above in connection with FIG. 3 (304).

The method 400 includes retrieving, by the computing device, information associated with an offer for sale, by a second vendor, of the at least one of the good and the service, the retrieved information including a second price (406). In some embodiments, the search module 210 retrieves this information as set forth above in connection with FIG. 3 (306).

The method 400 includes determining, by the computing device, that the first price is higher than the second price (408). In some embodiments, the price modification module 204 performs this price comparison step in the manner described above in connection with step 308 of FIG. 3.

The method 400 includes automatically modifying, by the computing device, the first price so that the first price is substantially equal to the second price based on the determination (410). In one embodiment, the method 400 includes automatically modifying, by the computing device, the first price so that the first price is lower than the second price. In some embodiments, the automatic modification is performed by the price modification module 204 as described above in connection with step 310 of FIG. 3 above.

The method 400 includes publishing the modified price in a form with which the user may acquire the at least one of the good and the service at the modified first price from the first vendor without negotiation (412). This is accomplished by the publishing module 208 as set forth above in connection with FIG. 3 (312).

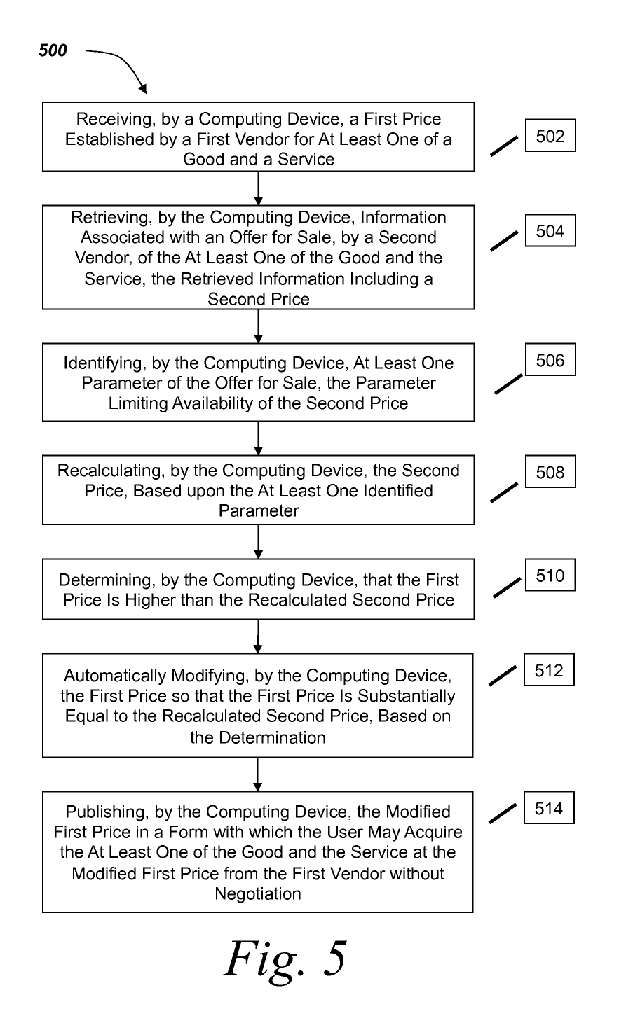

Referring now to FIG. 5, a flow diagram depicts an embodiment of a method 500 for automatic, pre-sale price matching. In brief overview, the method 500 includes receiving, by a computing device, a first price established by a first vendor for at least one of a good and a service (502). The method 500 includes retrieving, by the computing device, information associated with an offer for sale, by a second vendor, of the at least one of the good and the service, the retrieved information including a second price (504). The method 500 includes identifying, by the computing device, at least one parameter of the offer for sale, the parameter limiting availability of the second price (506). The method 500 includes recalculating, by the computing device, the second price, based upon the at least one identified parameter (508). The method 500 includes determining, by the computing device, that the first price is higher than the recalculated second price (510). The method 500 includes automatically modifying, by the computing device, the first price so that the first price is substantially equal to the recalculated second price, based on the determination (512). The method 500 includes publishing, by the computing device, the modified first price in a form with which the user may acquire the at least one of the good and the service at the modified first price from the first vendor without negotiation (514).

Referring now to FIG. 5 in greater detail, and in connection with FIGS. 2A-2B and 3, the computing device 102 receiving, by a computing device, a first price established by a first vendor for at least one of a good and a service (502). In one embodiment, the computing device 102 receives from a scanning device 212, data captured from a scanned price code, the data including the first price. The computing device 102 may be in communication with the scanning device 212, as described above in connection with FIGS. 2A-2B and 3. The scanning device 212 may include a scanner 202 that scans a price code 214 as described above in connection with FIGS. 2A-2B and 3.

The method 500 includes retrieving, by the computing device, information associated with an offer for sale, by a second vendor, of the at least one of the good and the service, the retrieved information including a second price (504). In some embodiments, the search module 210 performs the retrieval as described above in connection with step 310 of FIG. 3. In some embodiments, the search module 210 retrieves the information by retrieving information associated with each of a plurality of offers for sale from each of a plurality of vendors, the retrieved information including a price associated with each offer for sale, determining which of the plurality of offers for sale is associated with the lowest price included in the plurality of offers for sale, and selecting, for comparison with the first price, the determined offer for sale.

The method 500 includes identifying, by the computing device, at least one parameter of the offer for sale, the parameter limiting availability of the second price (506). In some embodiments, the price modification module 204 performs the identification as described above in connection with step 308 of FIG. 3.

The method 500 includes recalculating, by the computing device, the second price, based upon the at least one identified parameter (508). In some embodiments, the price modification module 204 performs the recalculation as described above in connection with step 308 of FIG. 3.

The method 500 includes determining, by the computing device, that the first price is higher than the recalculated second price (510). In some embodiments, the price modification module 204 performs the determination as described above in connection with step 308 of FIG. 3.

The method 500 includes automatically modifying, by the computing device, the first price so that the first price is substantially equal to the recalculated second price, based on the determination (512). In some embodiments, the price modification module 204 performs the automatic modification as described above in connection with step 310 of FIG. 3. In some embodiments, the price modification module 204 automatically modifies the price by maintaining, in memory accessible to the computing device, a minimum price value for the at least one of the good and the service, determining that the minimum price is higher than the second price, and modifying the first price so that the first price is substantially equal to the minimum price. In another embodiment, the price modification module 204 performs the automatic price modification by automatically modifying the first price so that the first price is lower than the recalculated second price, based on the determination.

The method 500 includes publishing, by the computing device, the modified first price in a form with which the user may acquire the at least one of the good and the service at the modified first price from the first vendor without negotiation (514). In some embodiments, the publishing module 208 performs the publication as described above in connection with step 312 of FIG. 3. In some embodiments, the publishing module 208 publishes the modified first price by transmitting the modified first price to a computing device maintained by the vendor.

The method and systems described above permit customers to comparison shop in the instant before purchase without having to perform any legwork or research themselves. The customer can present the modified price to the vendor, confident that it is the best deal the customer is likely to encounter, and that no delays, haggling, or paperwork stand between the customer and the deal. The vendor in turn can advertise superior pricing with confidence and know that the automatic nature of the transaction will minimize necessary employee training The various embodiments set forth above allow vendors and customers to strike a balance between customers' needs for freedom and frugality, and vendors' interests in protecting their profit margins. Integration of the methods and systems described above into the vendors' payment processing machines could make all the technology essentially invisible to more traditional shoppers, seamlessly carrying them into the mobile shopping marketplace.

The methods and systems described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, Python, C, C++, C#, JAVA, Ruby, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions described in this document by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices; firmware; programmable logic; hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for automatic, pre-sale price matching, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for automatic, pre-sale price matching, the method comprising:
receiving, by a computing device, a first price established by a first vendor for at least one of a good and a service;
retrieving, by the computing device, information associated with an offer for sale, by a second vendor, of the at least one of the good and the service, the retrieved information including a second price;
identifying, by the computing device, at least one parameter of the offer for sale, the parameter limiting availability of the second price;
recalculating, by the computing device, the second price, based upon the at least one identified parameter;
determining, by the computing device, that the first price is higher than the recalculated second price;
automatically modifying, by the computing device, the first price so that the first price is substantially equal to the recalculated second price, based on the determination; and
publishing, by the computing device, the modified first price in a form with which the user may acquire the at least one of the good and the service at the modified first price from the first vendor without negotiation.

2. The method of claim 1, wherein receiving further comprises receiving, by the computing device, from a scanning device, data captured from a scanned price code, the data including the first price.

3. The method of claim 1, wherein retrieving further comprises:
retrieving, by the computing device, information associated with each of a plurality of offers for sale from each of a plurality of vendors, the retrieved information including a price associated with each offer for sale;
determining, by the computing device, which of the plurality of offers for sale is associated with the lowest price included in the plurality of offers for sale; and
selecting, for comparison with the first price, the determined offer for sale.

4. The method of claim 1, wherein automatically modifying further comprises:
maintaining, in memory accessible to the computing device, a minimum price value for the at least one of the good and the service;
determining, by the computing device, that the minimum price is higher than the second price; and
modifying the first price so that the first price is substantially equal to the minimum price.

5. The method of claim 1, wherein automatically modifying further comprises automatically modifying, by the computing device, the first price so that the first price is lower than the recalculated second price, based on the determination.

6. The method of claim 1, wherein publishing further comprises transmitting the modified first price to a computing device maintained by the vendor.

7. A system for automatic, pre-sale price matching, the system comprising:
a computing device receiving data captured from a scanned price code associated with at least one of a good and a service offered for sale by a first vendor;
a price capture module executing on the computing device and identifying, based upon the received data, a first price established by the vendor for the at least one of the good and the service;
a search module executing on the computing device and retrieving information associated with an offer for sale, by a second vendor, of the at least one of the good and the service, the retrieved information including a second price;
a price modification module executing on the computing device, identifying at least one parameter of the offer for sale, the parameter limiting availability of the second price, recalculating the second price, based upon the at least one identified parameter, determining that the first price is higher than the recalculated second price, and automatically modifying the first price so that the first price is substantially equal to the recalculated second price, based on the determination; and
a publishing module executing on the computing device and publishing the modified first price in a form with which the user may acquire the at least one of the good and the service at the modified first price from the first vendor without negotiation.

8. The system of claim 7 further comprising a scanner in communication with the computing device.

9. The system of claim 7 further comprising a payment processing machine maintained by the first vendor and receiving, from the publishing module, the modified first price.
